(19) United States
(12) Patent Application Publication
(10) Pub. No.: US 2024/0294407 A1
(43) Pub. Date: Sep. 5, 2024

(54) DEVICE AND PROCESS FOR ELECTROCHEMICAL TREATMENT OF WASTEWATER WITH SCREENING CURRENT COLLECTOR-BASED FLOW ANODE

(71) Applicant: Guangdong University of Technology, Guangzhou (CN)

(72) Inventors: Jinxing MA, Guangzhou (CN); Daoyuan ZU, Guangzhou (CN); Kui YANG, Guangzhou (CN); Jiazhou HE, Guangzhou (CN); Runsheng XU, Guangzhou (CN); Di HE, Guangzhou (CN); Zhifeng YANG, Guangzhou (CN)

(73) Assignee: Guangdong University of Technology, Guangzhou (CN)

(21) Appl. No.: 18/231,263

(22) Filed: Aug. 8, 2023

(30) Foreign Application Priority Data
Mar. 1, 2023 (CN) 202310179565.X

(51) Int. Cl. C02F 1/467; C02F 1/461

(52) U.S. Cl. CPC C02F 1/4672; C02F 1/46114; C02F 2001/46133; C02F 2001/46152; C02F 2201/46135; C02F 2201/46145

(57) ABSTRACT

A device and process for electrochemical treatment of wastewater with a screening current collector-based flow anode are provided. The device includes: a shell, where an interior of the shell is a cavity structure, and the shell is provided with a water inlet and a water outlet; a screening current collector structure, where the screening current collector structure includes a screening anode current collector and a cathode current collector, a cathode/anode separator is provided between the screening anode current collector and the cathode current collector, and the screening anode current collector and the cathode current collector each are connected to an external circuit; an anode cell and a cathode cell, where the anode cell and the cathode cell are formed through division of the cavity structure, and an electrolyte is provided in each of the anode cell and the cathode cell; and a flow anode suspended in the anode cell.

### CROSS REFERENCE TO THE RELATED APPLICATIONS

This application is based upon and claims priority to Chinese Patent Application No. 202310179565.X, filed on Mar. 1, 2023, the entire contents of which are incorporated herein by reference.

### TECHNICAL FIELD

The present disclosure relates to the technical field of wastewater treatment, and in particular relates to a device and process for electrochemical treatment of wastewater with a screening current collector-based flow anode.

### BACKGROUND

This part is merely intended to provide background information related to the present disclosure, and does not necessarily constitute the prior art.

With the continuous advancement of industrialization and the continuous growth of population size, the problem of water shortage has become increasingly prominent. Under the premise that the overall water resources are difficult to increase, the development of efficient advanced wastewater treatment and reuse technologies to achieve the recycling of water resources is the only way for human development. Electrochemical advanced oxidation processes (EAOPs) are considered to be one of the most environmentally friendly wastewater treatment technologies because they do not require the addition of additional chemical reagents and can directly allow water electrolysis to produce strongly-oxidative hydroxyl radicals (·OH). During water electrolysis, an anode needs to be kept at a high potential to produce hydroxyl radicals (equation 1). This hinders the industrialization of EAOPs by significantly increasing the energy consumption of water purification, reducing the current efficiency, and promoting the competitive reaction of transfer of electrons in water to produce oxygen. Therefore, there is an urgent need to develop an efficient low-consumption electrochemical wastewater treatment and reuse technology.

$${H}_{2} O \to •OH ( aq ) + ( {H}^{+} + {e}^{-} ) {E}^{0} = 2.38 V \qquad ( 1 )$$

The use of an anode with a high oxygen evolution potential (OEP) can significantly reduce the occurrence of a water electrolysis reaction to produce oxygen and promote the production of hydroxyl radicals. Li Xueming et al. disclose a stannic oxide electrode with a high OEP (application No. CN202110101040.5). The stannic oxide electrode tends to produce increased hydroxyl radicals (·OH) during the electrochemical oxidation process, which can improve the catalytic oxidation capacity and current efficiency of the electrode and allow the efficient removal of phenol. Zhao Guohua et al. disclose a preparation method of an electrode with a high OEP to treat fluorine-containing organic wastewater (application No. CN201010533729.7). The electrode has an OEP of 2.4 V or more, exhibits a strong oxidation capacity and high efficiency, and can allow efficient degradation of fluorine-containing aromatic hydrocarbon organic pollutants that are difficult to a biochemically treat and oxidize. Although the use of an anode with a high OEP can improve the current efficiency and enhance the electrocatalytic oxidation activity, the operation of the anode at a high electrode potential has problems such as high energy consumption and short life span.

A water electrolysis route in which single electron transfer occurs at an anode to produce hydroxyl radicals is provided, and the water electrolysis route includes two elementary reactions (equation (2) and equation (3)), where an electrode potential required for O—H bond breaking of water on the surface of the electrode to produce adsorbed hydroxyl (*OH) is much lower than an electrode potential required for production of a free hydroxyl radical (·OH).

$${H}_{2} O + * \to * OH + ( {H}^{+} + {e}^{-} ) \qquad ( 2 )$$

$$* OH \to •OH ( aq ) + * \qquad ( 3 )$$

In addition, existing studies have shown that the adsorbed hydroxyl (*OH) has a potential to oxidize a variety of organic pollutants. However, because there is a boundary layer (about 100 μm) in a traditional flat plate-type electrode, the mass transfer efficiency of pollutants around the electrode is greatly reduced, which is not conducive to the utilization of adsorbed hydroxyl radicals (*OH). The disclosed three-dimensional (3D) electrodes are characterized by the generation of dipoles on a surface of a particulate electrode to promote the degradation of pollutants. Because the above process does not allow single polarization and the adsorbed oxidant has a strong complexing capacity with electrons, there have been no reports or technical inventions relating to *OH. Therefore, the development of an EAOP based on adsorbed hydroxyl (*OH) is key to avoiding the high energy consumption of electrochemical oxidation.

### SUMMARY

The present disclosure provides a device and process for electrochemical treatment of wastewater with a screening current collector-based flow anode, and overcomes the problem that the existing EAOPs have disadvantages such as low efficiency and high energy consumption.

The technical solutions of the present disclosure are implemented as follows.

A device for electrochemical treatment of wastewater with a screening current collector-based flow anode is provided, including:
a shell, where an interior of the shell is a cavity structure, and the shell is provided with a water inlet and a water outlet each communicating with the cavity structure; and the water inlet is configured to feed the wastewater to be treated, and the water outlet is configured to discharge purified recycled water;
a screening current collector structure, where the screening current collector structure includes a screening anode current collector and a cathode current collector, a cathode/anode separator is provided between the screening anode current collector and the cathode current collector, and the screening anode current collector and the cathode current collector each are connected to an external circuit;
an anode cell and a cathode cell, where the anode cell and the cathode cell are formed through division of the cavity structure by the screening current collector structure, and an electrolyte is provided in each of the anode cell and the cathode cell; and
a flow anode suspended in the anode cell; where an unidirectional anodic bias voltage is applied to the screening current collector structure to allow polarization of the flow anode in contact with the screening current collector structure, and a water oxidation reaction is further allowed on a surface of the flow anode at a low voltage to produce adsorbed hydroxyl to make the flow anode conduct filtering solid-liquid separation (SLS) on a surface of the screening current collector structure, such that a particulate space stacking effect is formed to allow efficient removal of pollutants and effective interception of the flow anode.

As a further optimized technical solution, the device is a tube-in-tube device; and the cathode/anode separator and the cathode current collector are wound sequentially around the screening anode current collector.

As a further optimized technical solution, the device is a flat plate-type device; and the screening anode current collector, the cathode current collector, and the cathode/anode separator are arranged in parallel inside the shell in a clamping manner.

As a further optimized technical solution, the screening anode current collector has a porous structure with a pore size smaller than a particle size of the flow anode.

As a further optimized technical solution, the device further includes:
an anode terminal post, where the anode terminal post is connected to the screening anode current collector and extends out of the shell; and
a cathode terminal post, where the cathode terminal post is connected to the cathode current collector and extends out of the shell; and the screening anode current collector and the cathode current collector are connected to the external circuit through the anode terminal post and the cathode terminal post, respectively.

As a further optimized technical solution, a material of the screening anode current collector is selected from the group consisting of SnO₂—Sb, PbO₂, a flexible carbon material, a platinum mesh, IrTa, and IrRu.

As a further optimized technical solution, a material of the cathode current collector is selected from the group consisting of a titanium mesh, a platinum mesh, and a stainless steel mesh.

As a further optimized technical solution, a material of the flow anode is selected from the group consisting of a metal oxide, a carbon material, and a composite, and has a particle size in a range of 0.1 μm to 1,000 μm.

A process for electrochemical treatment of wastewater with a screening current collector-based flow anode is provided, where the process is implemented by the device for electrochemical treatment of wastewater with a screening current collector-based flow anode, and includes the following steps:
introducing the wastewater through the water inlet, and starting stirring to keep an anode material suspended;
applying an unidirectional anodic bias voltage to the screening current collector structure to allow polarization of the flow anode in contact with the screening current collector structure, and further allowing a water oxidation reaction on a surface of the flow anode at a low voltage to produce adsorbed hydroxyl to make the flow anode conduct filtering SLS on a surface of the screening current collector structure, such that a particulate space stacking effect is formed to allow efficient removal of pollutants and effective interception of the flow anode; and
discharging purified recycled water through the water outlet.

As a further optimized technical solution, the process further includes any one or more selected from the group consisting of the following technical features:
A. the applied anode potential is 0.5 V to 2.0 V vs a standard hydrogen electrode (SHE) potential;
B. the device for electrochemical treatment of wastewater with a screening current collector-based flow anode operates in a continuous flow mode, and a water flux of the screening anode current collector is 0 m³/m²/h to 1 m³/m²/h; and
C. magnetic stirring or mechanical stirring at a stirring rate of 100 rpm to 250 rpm is adopted to keep the flow anode suspended in the electrolyte.

With the above technical solutions, the present disclosure has the following beneficial effects:

1. In the device for electrochemical treatment of wastewater with a screening current collector-based flow anode provided by the present disclosure, pollutants are subjected to oxidative degradation with adsorbed hydroxyl (*OH) generated due to single electron transfer of water on the flow anode, which solves the problem that the traditional flat plate-type electro-oxidation device has low mass transfer efficiency due to a boundary layer, and allows efficient oxidative degradation of the pollutants. Compared with the traditional hydroxyl radical (·OH)-dominated electro-oxidation wastewater treatment technology, the process of the present disclosure requires a lower reaction potential for adsorbed hydroxyl of reactive oxygen species (ROS), which can significantly reduce the anode potential and energy consumption.

2. In the device for electrochemical treatment of wastewater with a screening current collector-based flow anode provided by the present disclosure, the screening anode current collector has a porous structure, which is a structural innovation of the device for electro-oxidation treatment of wastewater with a flow electrode; the use of the screening anode current collector with a pore size smaller than a particle size of the flow anode can allow the effective interception of the flow electrode and the efficient penetration of wastewater without using an ion exchange membrane as a separator between the anode current collector and the cathode current collector; and when the flow anode conducts filtering SLS on a surface of the porous screening current collector, a particulate space stacking effect is formed, which significantly increases a mass concentration of the electrode near the surface of the current collector and further improves the efficiency of oxidation of pollutants by *OH.

3. The device for electrochemical treatment of wastewater with a screening current collector-based flow anode provided by the present disclosure has a simple structure, a low production cost, and convenient maintenance and management. When the device is used to treat wastewater, a process flow is simple, and the pollutant removal efficiency is high. Thus, the device can be applied to large-scale wastewater treatment.

4. When the process for electrochemical treatment of wastewater with a screening current collector-based flow anode provided by the present disclosure is used to treat wastewater, an unidirectional anodic bias voltage is applied to the screening current collector structure to allow polarization of the flow anode in contact with the screening current collector structure, and a water oxidation reaction is further allowed on a surface of the flow anode at a low voltage to produce adsorbed hydroxyl to make the flow anode conduct filtering SLS on a surface of the screening current collector structure, such that a particulate space stacking effect is formed to allow efficient removal of pollutants and effective interception of the flow anode.

### BRIEF DESCRIPTION OF THE DRAWINGS

To describe the technical solutions in the embodiments of the present disclosure or in the prior art clearly, the accompanying drawings required for describing the embodiments or the prior art will be described briefly below. Apparently, the accompanying drawings in the following description show some embodiments of the present disclosure, and a person of ordinary skill in the art may still derive other accompanying drawings from these accompanying drawings without creative efforts.

FIG. 1 is a schematic structural diagram of the device for electrochemical treatment of wastewater with a screening current collector-based flow anode in the present disclosure, where the device is a tube-in-tube device.

FIG. 2 is a schematic structural diagram of the device for electrochemical treatment of wastewater with a screening current collector-based flow anode in the present disclosure, where the device is a flat plate-type device.

FIG. 3 shows removal rates of carbamazepine (CBZ) in Examples 4 and 5.

In the figures: 1: base; 2: screw; 3: water outlet; 4: shell; 5: nut; 6: top cover; 7: anode terminal post; 8: cathode terminal post; 9: water inlet; 10: cathode current collector; 11: cathode/anode separator; 12: screening anode current collector; 13: anode cell; and 14: cathode cell.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts should fall within the protection scope of the present disclosure.

### Example 1

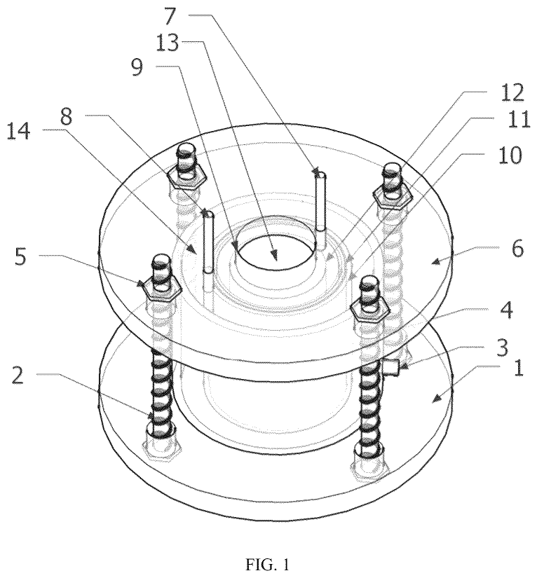

As shown in FIG. 1, a device for electrochemical treatment of wastewater with a screening current collector-based flow anode is provided, including: shell 4, a screening current collector structure, anode cell 13, cathode cell 14, and a flow anode.

An interior of the shell 4 is a cavity structure, and the shell 4 is provided with water inlet 9 and water outlet 3 each communicating with the cavity structure; and the water inlet 9 is configured to feed the wastewater to be treated, and the water outlet 3 is configured to discharge purified recycled water.

The screening current collector structure includes screening anode current collector 12 and cathode current collector 10, cathode/anode separator 11 is provided between the screening anode current collector 12 and the cathode current collector 10, and the screening anode current collector 12 and the cathode current collector 10 each are connected to an external circuit.

The anode cell 13 and the cathode cell 14 are formed through division of the cavity structure by the screening current collector structure, and an electrolyte is provided in each of the anode cell 13 and the cathode cell 14.

The flow anode is suspended in the anode cell 13.

When the device for electrochemical treatment of wastewater with a screening current collector-based flow anode is used in wastewater treatment, an unidirectional anodic bias voltage is applied to the screening current collector structure to allow polarization of the flow anode in contact with the screening current collector structure, and a water oxidation reaction is further allowed on a surface of the flow anode at a low voltage to produce adsorbed hydroxyl (*OH); and since a mass transfer process on the surface of the flow anode is greatly enhanced, the interfacial oxidant *OH can react efficiently with pollutants, and when the flow anode conducts filtering SLS on a surface of the porous screening current collector, a particulate space stacking effect is formed, which significantly increases a mass concentration of the electrode near the surface of the current collector and further improves the efficiency of oxidation of pollutants by *OH thereby allowing efficient removal of pollutants and effective interception of the flow anode.

Based on different current collector structures, the device of the present disclosure includes a tube-in-tube device and a flat plate-type device. The device in this example is a tube-in-tube device; and the cathode/anode separator 11 and the cathode current collector 10 are wound sequentially around the screening anode current collector 12. The tube-in-tube device further includes base 1, screw 2, nut 5, and top cover 6. The shell 4 is cylindrical, the base 1 and the top cover 6 each have a disc plate-type structure, and a plurality of screws 2 penetrate through the base 1 and the top cover 6 and are fixed by nuts 5.

The screening anode current collector 12 has a porous structure with a pore size smaller than a particle size of the flow anode. The present disclosure allows a structural innovation of the device for electro-oxidation treatment of wastewater with a flow electrode; the use of the screening anode current collector with a pore size smaller than a particle size of the flow anode can allow the effective interception of the flow electrode and the efficient penetration of wastewater without using an ion exchange membrane as a separator between the anode current collector and the cathode current collector; and when the flow anode conducts filtering SLS on a surface of the porous screening current collector, a particulate space stacking effect is formed, which significantly increases a mass concentration of the electrode near the surface of the current collector and further improves the efficiency of oxidation of pollutants by *OH.

The device of the present disclosure further includes anode terminal post 7 and cathode terminal post 8. The anode terminal post 7 is connected to the screening anode current collector 12 and extends out of the shell. The cathode terminal post 8 is connected to the cathode current collector 10 and extends out of the shell. The screening anode current collector 12 and the cathode current collector 10 are connected to the external circuit through the anode terminal post 7 and the cathode terminal post 8, respectively.

A material of the screening anode current collector 12 includes, but is not limited to, SnO₂—Sb, PbO₂, a flexible carbon material, a platinum mesh, IrTa, and IrRu.

A material of the cathode current collector 10 includes, but is not limited to, a titanium mesh, a platinum mesh, and a stainless steel mesh.

A material of the flow anode includes, but is not limited to, a metal oxide, a carbon material, and a composite, and has a particle size in a range of 0.1 μm to 1,000 μm.

### Example 2

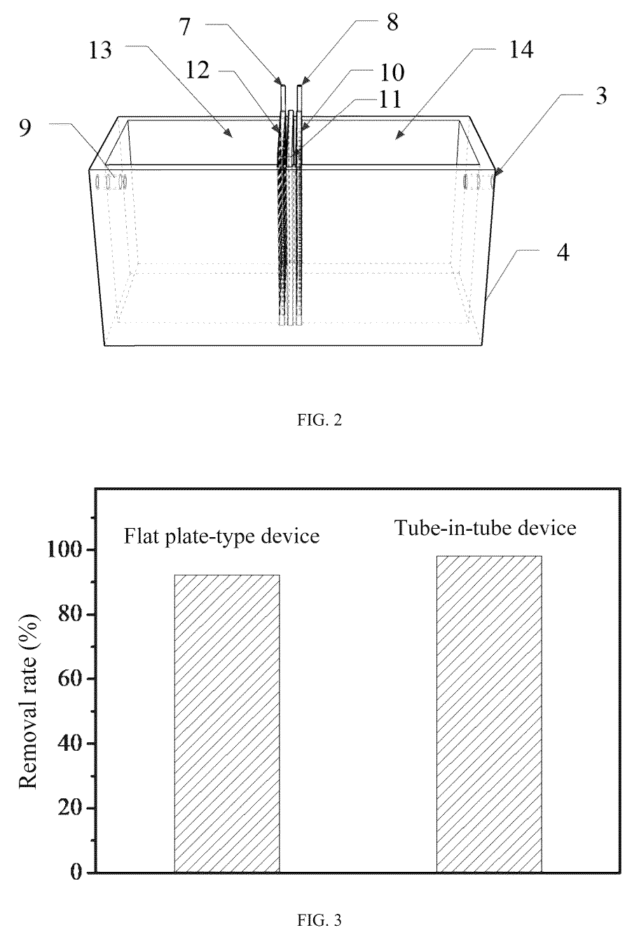

As shown in FIG. 2, this example discloses a device for electrochemical treatment of wastewater with a screening current collector-based flow anode, which is different from the device in Example 1 in that the device in this example is a flat plate-type device; the screening anode current collector 12, the cathode current collector 10, and the cathode/anode separator 11 are clamped in parallel inside the shell 4 through clamping grooves; and the clamping grooves are arranged at a spacing of 0.05 cm to 0.5 cm. In this example, the shell 4 is rectangular, the water inlet 9 is formed on one side of the shell 4, and the water outlet 3 is formed on the other side of the shell 4.

### Example 3

On the basis of Example 1 or 2, this example discloses a process for electrochemical treatment of wastewater with a screening current collector-based flow anode, where the process is implemented by the device for electrochemical treatment of wastewater with a screening current collector-based flow anode, and includes the following steps:

The wastewater is introduced through the water inlet 9, a flow anode material is added to the anode cell 13, and stirring is started to keep the anode material suspended. Magnetic stirring or mechanical stirring at a stirring rate of 100 rpm to 250 rpm is adopted to keep the flow anode suspended in an electrolyte.

An unidirectional anodic bias voltage is applied to the screening current collector structure to allow polarization of the flow anode in contact with the screening current collector structure The applied anode potential is 0.5 V to 2.0 V vs an SHE potential, and can be provided by a device including, but not limited to, a regulated power supply, a potentiostat, and an electrochemical workstation. A water oxidation reaction is further allowed on a surface of the flow anode at a low voltage to produce adsorbed hydroxyl to make the flow anode conduct filtering SLS on a surface of the screening current collector structure, such that a particulate space stacking effect is formed to allow efficient removal of pollutants and effective interception of the flow anode.

Purified recycled water is discharged through the water outlet.

The device for electrochemical treatment of wastewater with a screening current collector-based flow anode operates in a continuous flow mode, and a water flux of the screening anode current collector 12 is 0 m³/m²/h to 1 m³/m²/h.

### Example 4

On the basis of Example 1, this example discloses a specific implementation of an electrochemical oxidation treatment of the typical organic pollutant CBZ by the tube-in-tube device, and specific experimental steps are as follows:

A three-electrode system was constructed with a porous Ti/SnO₂—Sb electrode as an anode current collector, a 100-mesh titanium mesh as a cathode current collector, and a standard silver/silver chloride reference electrode, where the anode current collector and the cathode current collector were separated by a plastic mesh. A total volume of a constructed anode cell was 100 mL. 5.0 g of Tr₄O₇ particles passing through a 500-mesh screen mesh was added as a flow electrode to the anode cell, and CBZ-containing wastewater was introduced through the water inlet at a flow rate of 2 mL min⁻¹. Magnetic stirring was conducted at a stirring speed of 500 rpm to keep the flow electrode uniformly suspended in the anode cell during a reaction. The anode current collector and the cathode current collector each were allowed to communicate with a regulated power supply. An anode potential was recorded, and a voltage input of the regulated power supply was adjusted to ensure that the anode potential was 1.5 V vs SHE. Treated wastewater was collected at the water outlet to determine a removal rate of CBZ.

### Example 5

On the basis of Example 2, this example discloses an implementation of an electrochemical oxidation treatment of the typical organic pollutant CBZ by the flat plate-type device, and specific experimental steps are as follows:

A three-electrode system was constructed with a Ti/SnO₂—Sb electrode as an anode current collector, a 100-mesh titanium mesh as a cathode current collector, and a standard silver/silver chloride reference electrode, where the anode current collector and the cathode current collector were separated by a plastic mesh. A total volume of a constructed anode cell was 100 mL. 5.0 g of Ti₄O₇ particles passing through a 500-mesh screen mesh was added as a flow electrode to the anode cell, and CBZ-containing wastewater was introduced through the water inlet at a flow rate of 2 mL min⁻¹. Magnetic stirring was conducted at a stirring speed of 500 rpm to keep the flow electrode uniformly suspended in the anode cell during a reaction. The anode current collector and the cathode current collector each were allowed to communicate with a regulated power supply. An anode potential was recorded, and a voltage input of the regulated power supply was adjusted to ensure that the anode potential was 1.5 V vs SHE. Treated wastewater was collected at the water outlet to determine a removal rate of CBZ.

FIG. 3 shows removal rates of CBZ in Examples 4 and 5. It can be seen from FIG. 3 that, under the same conditions, a removal rate of CBZ of the tube-in-tube device (98%) is higher than a removal rate of CBZ of the flat plate-type device (92.2%).

The above descriptions are merely preferred examples of the present disclosure, and are not intended to limit the present disclosure. Any modifications, equivalent replacements, improvements, and the like made within the spirit and principle of the present disclosure shall be all included in the protection scope of the present disclosure.

What is claimed is:

1. A device for an electrochemical treatment of a wastewater with a screening current collector-based flow anode, comprising:
a shell, wherein an interior of the shell is a cavity structure, and the shell is provided with a water inlet and a water outlet each communicating with the cavity structure; and the water inlet is configured to feed the wastewater to be treated, and the water outlet is configured to discharge purified recycled water;
a screening current collector structure, wherein the screening current collector structure comprises a screening anode current collector and a cathode current collector, a cathode/anode separator is provided between the screening anode current collector and the cathode current collector, and the screening anode current collector and the cathode current collector are each connected to an external circuit;
an anode cell and a cathode cell, wherein the anode cell and the cathode cell are formed through a division of the cavity structure by the screening current collector structure, and an electrolyte is provided in each of the anode cell and the cathode cell; and
a flow anode suspended in the anode cell; wherein an unidirectional anodic bias voltage is applied to the screening current collector structure to allow a polarization of the flow anode in contact with the screening current collector structure, and a water oxidation reaction is further allowed on a surface of the flow anode at a low voltage to produce an adsorbed hydroxyl to make the flow anode conduct a filtering solid-liquid separation (SLS) on a surface of the screening current collector structure, such that a particulate space stacking effect is formed to allow an efficient removal of pollutants and an effective interception of the flow anode; and
wherein the screening anode current collector has a porous structure with a pore size smaller than a particle size of the flow anode; and the flow anode has the particle size in a range of 0.1 μm to 1,000 μm.

2. The device for the electrochemical treatment of the wastewater with the screening current collector-based flow anode according to claim 1, wherein the device is a tube-in-tube device; and the cathode/anode separator and the cathode current collector are wound sequentially around the screening anode current collector.

3. The device for the electrochemical treatment of the wastewater with the screening current collector-based flow anode according to claim 1, wherein the device is a flat plate-type device; and the screening anode current collector, the cathode current collector, and the cathode/anode separator are arranged in parallel inside the shell in a clamping manner.

4. The device for the electrochemical treatment of the wastewater with the screening current collector-based flow anode according to claim 1, further comprising:
an anode terminal post, wherein the anode terminal post is connected to the screening anode current collector and extends out of the shell; and
a cathode terminal post, wherein the cathode terminal post is connected to the cathode current collector and extends out of the shell; and the screening anode current collector and the cathode current collector are connected to the external circuit through the anode terminal post and the cathode terminal post, respectively.

5. The device for the electrochemical treatment of the wastewater with the screening current collector-based flow anode according to claim 1, wherein a material of the screening anode current collector is selected from the group consisting of SnO2-Sb, PbO2, a flexible carbon material, a platinum mesh, IrTa, and IrRu.

6. The device for the electrochemical treatment of the wastewater with the screening current collector-based flow anode according to claim 1, wherein a material of the cathode current collector is selected from the group consisting of a titanium mesh, a platinum mesh, and a stainless steel mesh.

7. The device for the electrochemical treatment of the wastewater with the screening current collector-based flow anode according to claim 1, wherein a material of the flow anode is selected from the group consisting of a metal oxide and a carbon material.

8. A process for an electrochemical treatment of wastewater with a screening current collector-based flow anode, wherein the process is implemented by the device for the electrochemical treatment of the wastewater with the screening current collector-based flow anode according to claim 1, and comprises the following steps:
introducing the wastewater through the water inlet, and starting stirring to keep an anode material suspended;
applying the unidirectional anodic bias voltage to the screening current collector structure to allow the polarization of the flow anode in contact with the screening current collector structure, and further allowing the water oxidation reaction on the surface of the flow anode at the low voltage to produce the adsorbed hydroxyl to make the flow anode conduct the filtering SLS on the surface of the screening current collector structure, such that the particulate space stacking effect is formed to allow the efficient removal of pollutants and the effective interception of the flow anode; and
discharging the purified recycled water through the water outlet.

9. The process for the electrochemical treatment of the wastewater with the screening current collector-based flow anode according to claim 8, further comprising one or more selected from the group consisting of the following technical features:
A. an applied anode potential is 0.5 V to 2.0 V vs a standard hydrogen electrode (SHE) potential;
B. the device for the electrochemical treatment of the wastewater with the screening current collector-based flow anode operates in a continuous flow mode, and a water flux of the screening anode current collector is 0 m³/m²/h to 1 m³/m²/h; and
C. a magnetic stirring or a mechanical stirring at a stirring rate of 100 rpm to 250 rpm is adopted to keep the flow anode suspended in the electrolyte.

10. The device for the electrochemical treatment of the wastewater with the screening current collector-based flow anode according to claim 2, wherein a material of the screening anode current collector is selected from the group consisting of SnO₂—Sb, PbO₂, a flexible carbon material, a platinum mesh, IrTa, and IrRu.

11. The device for the electrochemical treatment of the wastewater with the screening current collector-based flow anode according to claim 3, wherein a material of the screening anode current collector is selected from the group consisting of SnO₂—Sb, PbO₂, a flexible carbon material, a platinum mesh, IrTa, and IrRu.

12. The device for the electrochemical treatment of the wastewater with the screening current collector-based flow anode according to claim 4, wherein a material of the screening anode current collector is selected from the group consisting of SnO₂—Sb, PbO₂, a flexible carbon material, a platinum mesh, IrTa, and IrRu.

13. The device for the electrochemical treatment of the wastewater with the screening current collector-based flow anode according to claim 2, wherein a material of the cathode current collector is selected from the group consisting of a titanium mesh, a platinum mesh, and a stainless steel mesh.

14. The device for the electrochemical treatment of the wastewater with the screening current collector-based flow anode according to claim 3, wherein a material of the cathode current collector is selected from the group consisting of a titanium mesh, a platinum mesh, and a stainless steel mesh.

15. The device for the electrochemical treatment of the wastewater with the screening current collector-based flow anode according to claim 4, wherein a material of the cathode current collector is selected from the group consisting of a titanium mesh, a platinum mesh, and a stainless steel mesh.

16. The device for the electrochemical treatment of the wastewater with the screening current collector-based flow anode according to claim 2, wherein a material of the flow anode is selected from the group consisting of a metal oxide and a carbon material.

17. The device for the electrochemical treatment of the wastewater with the screening current collector-based flow anode according to claim 3, wherein a material of the flow anode is selected from the group consisting of a metal oxide and a carbon material.

18. The device for the electrochemical treatment of the wastewater with the screening current collector-based flow anode according to claim 4, wherein a material of the flow anode is selected from the group consisting of a metal oxide and a carbon material.

19. The process for the electrochemical treatment of the wastewater with the screening current collector-based flow anode according to claim 8, wherein the device is a tube-in-tube device; and the cathode/anode separator and the cathode current collector are wound sequentially around the screening anode current collector.

20. The process for the electrochemical treatment of the wastewater with the screening current collector-based flow anode according to claim 8, wherein the device is a flat plate-type device; and the screening anode current collector, the cathode current collector, and the cathode/anode separator are arranged in parallel inside the shell in a clamping manner.
